(19) United States
(12) Patent Application Publication
(10) Pub. No.: US 2014/0095225 A1
(43) Pub. Date: Apr. 3, 2014

(54) SYSTEM AND METHOD FOR EVENT TICKETING UTILIZING AN ARTICLE DISPENSING MACHINE

(71) Applicant: Redbox Automated Retail, LLC, Oakbrook Terrace, IL (US)

(72) Inventors: Heidemarie W. Williams, Homer Glen, IL (US); Jason Arthur Rubinstein, Lake Forest, IL (US); Brittany Canty, Lombard, IL (US); Reina Sulis Santiago, Oakbrook Terrace, IL (US); Tara Devlin, Chicago, IL (US); Adam Richard Fischer, Willowbrook, IL (US)

(21) Appl. No.: 14/042,635

(22) Filed: Sep. 30, 2013

Related U.S. Application Data
(60) Provisional application No. 61/741,774, filed on Oct. 3, 2012.

(51) Int. Cl. G06Q 10/06

(52) U.S. Cl. CPC G06Q 10/06
USPC 705/5

(57) ABSTRACT

A system and method of event ticketing utilizing an article dispensing machine is disclosed. A ticket order transaction related to an event is managed at an article dispensing machine by presenting a series of simple and easy to understand interface pages on a user interface. A user interacts with the interface pages to make decisions on aspects of the ticket order transaction. A listing of events available for ticket ordering on the article dispensing machine is curated by reviewing prospective events. The listing is curated based on the location of the article dispensing machine, the priority ranking of the event, the date and time of the productions, the category of the events, the location of the venue relative to the article dispensing machine, and/or other factors. A hyper-local listing of events can be presented so that the events that are most likely relevant to users.

### CROSS-REFERENCE TO RELATED APPLICATIONS

This application claims priority to U.S. Provisional Application No. 61/741,774 which was filed on Oct. 3, 2012, entitled “SYSTEM AND METHOD FOR EVENT TICKETING UTILIZING AN ARTICLE DISPENSING MACHINE” which is hereby incorporated herein by reference in its entirety.

### TECHNICAL FIELD

This invention relates to a system and method for event ticketing utilizing an article dispensing machine. More particularly, the present invention provides a system and method for managing a ticket order transaction at an article dispensing machine and curating a listing of events for ticket ordering at the article dispensing machine.

### BACKGROUND AND SUMMARY OF THE INVENTION

While the present invention is often described herein with reference to a digital video disc, Blu-Ray disc, video game, and event ticketing distribution system, an application to which the present invention is advantageously suited, it will be readily apparent that the present invention is not limited to that application and can be employed in article dispensing systems used to distribute a wide variety of dispensable articles.

The digital video disc (DVD) player has been one of the most successful consumer electronics product launches in history. The market for DVD movie video, Blu-Ray movie video, and video game rentals is enormous and growing. Millions of households have acquired DVDs since they were introduced in 1997. In the first quarter of 2003 alone, it was estimated that well over three million DVD players were shipped to U.S. retailers.

In 2003, brick-and-mortar stores dominated the movie video and video game rental landscape in the U.S. Statistics showed that two brick-and-mortar companies controlled nearly sixty-five percent of the home video rental business. One element repeatedly cited for success of certain brick-and mortar store video rental franchises was perceived high availability of new video releases. Consumers want entertainment on demand, and through stocking multiple units of each new release, successful brick-and-mortar companies meet this consumer demand.

The foregoing indicates that there is a significant market potential for aligning regular routines of consumers (e.g., shopping, getting coffee, gas, or going to a convenience store) with their DVD, Blu-Ray, and video game rental activities. Moreover, there is a significant market potential for aligning the regular routines of consumer with event ticketing activities.

One improved article dispensing machine is disclosed in commonly owned U.S. Pat. No. 7,234,609, which is herein incorporated by reference in its entirety. The invention of the U.S. Pat. No. 7,234,609 and the present invention can function as an article dispensing machine-based distribution system that will typically have multiple units per article dispensing machine. The dispensing machines of the U.S. Pat. No. 7,234,609 and the present invention can stock up to two thousand DVDs, Blu-Ray, video games, or other discs (movies, games or other entertainment content), making the system competitive with existing brick-and-mortar video rental superstores. The dispensing machines can also provide event ticketing capabilities to make the system competitive with other event ticketing schemes. The dispensing machine and system of the U.S. Pat. No. 7,234,609 and the present invention distinguishes itself from stores and other event ticketing schemes by offering major benefits not conventionally offered by such stores, including additional cross-marketing programs (e.g., promotional rentals for a certain amount of dollars spent at the retail location) and convenience (e.g., open always).

The dispensing machine of the U.S. Pat. No. 7,234,609 and the present invention yields a competitive advantage in the DVD, Blu-Ray disc, video game, and event ticketing marketplace by offering consumers cross-marketing/promotional programs, convenience of selection (e.g., computer-based searches for movies and recommendations based on consumer profiles), and potentially extended hours (e.g., 24 hours a day, 7 days a week). The present invention employs a more cost-effective, convenient platform than brick-and-mortar stores and existing event ticketing schemes. In addition, with the present invention, dispensing machines can be situated in retail locations having high foot traffic, such as at a popular grocery store, restaurant, drug store, and/or other popular retail location.

The dispensing machine of the U.S. Pat. No. 7,234,609 and the present invention can be operated at a substantial savings over the costs associated with traditional brick-and-mortar stores. For example, the present invention does not require hourly employees manning the dispensing machines or restocking them with inventories, due to the ability of the article transport storage units to be delivered to/picked up from retail locations by third-party delivery services, such as traditional or contracted courier services.

Unlike brick-and-mortar stores, the dispensing machine of the U.S. Pat. No. 7,234,609 and the present invention does, not require an on-site store manager because all operational decisions can be made at a centralized location by a management team officed remote from the retail locations. Unlike brick-and-mortar stores, the dispensing machine of the U.S. Pat. No. 7,234,609 and the present invention does not require significant physical space. Unlike brick-and-mortar stores, the dispensing machine of the U.S. Pat. No. 7,234,609 and the present invention has low operating costs because heating or air conditioning is not necessarily required for the dispensing machines and they consume a relatively low level of electrical energy. In addition, the dispensing machine of the U.S. Pat. No. 7,234,609 has low maintenance costs and downtime.

The dispensing machine of the U.S. Pat. No. 7,234,609 and the present invention addresses the shortcomings of traditional brick-and-mortar stores in a convenient and cost-effective delivery vehicle having the added bonus of serving as an effective promotional platform that drives incremental sales to retail locations.

The dispensing machine of the U.S. Pat. No. 7,234,609 and the present invention is a fully automated, integrated DVD, Blu-Ray, video game, and event ticketing system. It preferably incorporates robust, secure, scalable software that provides a fully personalized user experience and real-time feedback to retail locations and advertisers, scalable hardware that leverages existing technologies such as touch screen, focused audio speakers and video monitors, and technology utilizing the Internet through a system website or mobile/consumer electronics device application. These technologies and others fill long-felt needs in the art. The dispensing machine of the U.S. Pat. No. 7,234,609 and the present invention functions as much as a promotional platform as it does a rental and purchase kiosk.

By utilizing the dispensing machines and the fully-interactive, real-time, linked Internet website or mobile/consumer electronics device applications, consumers can rent one or more DVDs, Blu-Ray discs, video games, or other entertainment content directly from dispensing machines as well as indirectly by making a rental reservation through the website or application for later pickup at a conveniently located machine. Consumers can also initiate and/or complete event ticketing transactions utilizing the dispensing machines. These dispensing machines are preferably networked with each other, with the inventory control and/or supply office and with the system website or application by phone-line, DSL, wireless network, or other Internet connection at each retail location. Through this linked network, the experience for each consumer can be customized based on a profile for each consumer, such as via personalized home pages and screens.

The present invention may manage a ticket order transaction at an article dispensing machine by presenting a series of simple and easy to understand interface pages to a user on a user interface of the article dispensing machine. The ticket order transaction can be related to an event having one or more productions. A production of an event is a particular performance of the event at a certain date, time, and venue. The interface pages presented on the user interface can include a production listing page that includes selectable listings of productions for the event, a quantity selection page for a particular production for receiving a ticket quantity input, a seat selection page including a ticket availability based on the ticket quantity input, a delivery selection page including one or more delivery options, and a purchase summary page for presenting a total price related to the ticket order transaction. Each of the interface pages may include one or more selectable listings and/or buttons. The production listing page can include a selectable reminder button that allows the user to input a communication address for receiving a reminder notification related to the event. The ticket availability listed on the seat selection page can include a best seats option and/or a best value option. The ticket order transaction may also include promotional up-selling and cross-selling of related products and service, including but not limited to parking passes, food and merchandise vouchers, and movie and game rentals. By presenting the series of interface pages, the user of the article dispensing machine may have an improved, streamlined, and convenient experience while performing a ticket order transaction.

The present invention may also curate a listing of events available for ticket ordering at an article dispensing machine. Prospective events can be reviewed to derive the listing of the events. Each of the events can be organized in one or more categories. Each of the events and each of the prospective events can include one or more productions and a priority ranking. The listing of events can be curated based on the location of the article dispensing machine, the priority ranking of the event, the date and time of the productions, the category of the events, the location of the venue relative to the article dispensing machine, and other factors. For a particular article dispensing machine, a hyper-local listing of events can be curated so that users of the article dispensing machine can view, browse, and purchase tickets to the events that are most likely relevant to the users.

Other features and advantages are provided by the following description and drawings.

### BRIEF DESCRIPTION OF THE DRAWINGS

FIG. 1 is an illustration of a system for communicating and processing information in a network of article dispensing machines and dispensing apparatus.

FIG. 2 is a perspective view of an article dispensing machine constructed in accordance with the principles of the present invention.

FIG. 3 is a block diagram illustrating a networked event ticketing system and connections including an article dispensing machine, an event ticketing management system, and ticket supplier systems.

FIG. 4 is a flowchart illustrating operations for managing a ticket order transaction at an article dispensing machine.

FIG. 5 is a flowchart illustrating operations for curating a listing of events available for ticket ordering at an article dispensing machine.

FIG. 6 is a flowchart illustrating operations for further curating a listing of events available for ticket ordering at an article dispensing machine.

FIG. 7 is an exemplary merchandising page related to managing a ticket order transaction at an article dispensing machine.

FIG. 8 is an exemplary events browse page related to managing a ticket order transaction at an article dispensing machine.

FIG. 9 is an exemplary production listing page related to managing a ticket order transaction at an article dispensing machine.

FIG. 10 is an exemplary reminder entry page related to managing a ticket order transaction at an article dispensing machine.

FIG. 11 is an exemplary quantity selection page related to managing a ticket order transaction at an article dispensing machine.

FIG. 12 is an exemplary seat selection page related to managing a ticket order transaction at an article dispensing machine.

FIG. 13 is an alternative exemplary seat selection page related to managing a ticket order transaction at an article dispensing machine.

FIG. 14 is another alternative exemplary seat selection page related to managing a ticket order transaction at an article dispensing machine.

FIG. 15 is an exemplary delivery selection page related to managing a ticket order transaction at an article dispensing machine.

FIG. 16 is an exemplary purchase summary page related to managing a ticket order transaction at an article dispensing machine.

FIG. 17 is an exemplary will call name entry page related to managing a ticket order transaction at an article dispensing machine.

FIG. 18 is an exemplary will call name entry page related to managing a ticket order transaction at an article dispensing machine.

FIG. 19 is an exemplary order confirmation communication page related to managing a ticket order transaction at an article dispensing machine.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

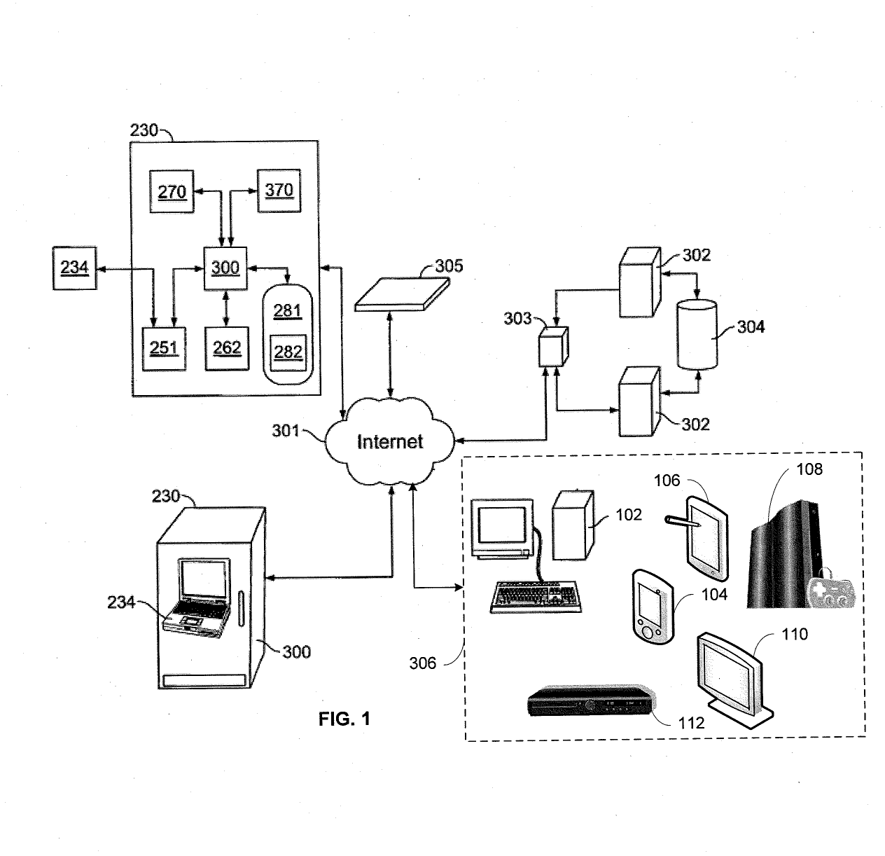

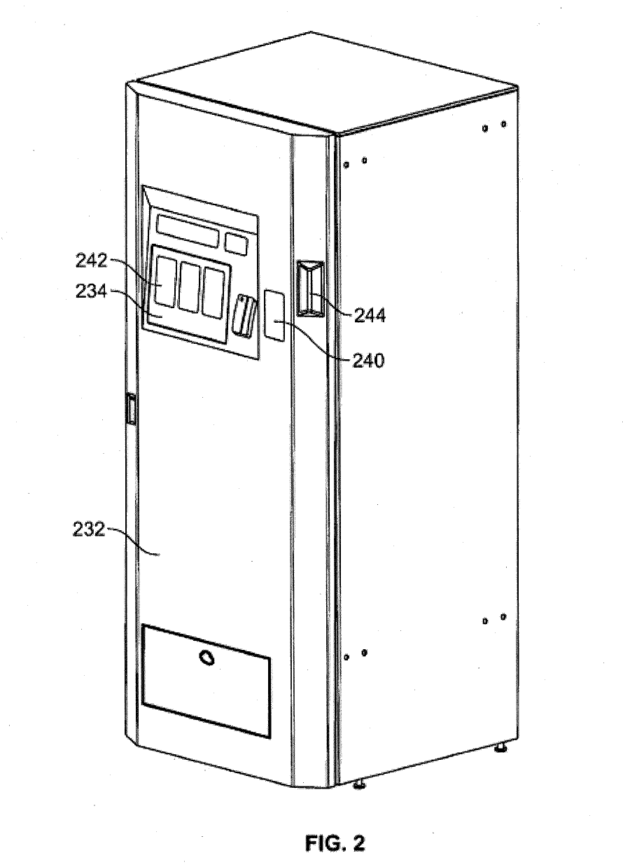

FIGS. 1-2 illustrate an article dispensing machine designated 230. Article dispensing machine 230 is one of a plurality of article dispensing machines included within an article distribution system having a plurality of such machines situated at a plurality of retail locations. The article dispensing machines of a particular article distribution system preferably form a network. As such, those machines are preferably in electrical communication with each other and with a central server or central controller.

As shown in FIG. 1, each article dispensing machine 230 includes a dispensing machine processor 300, also referred to herein as a vending controller, which is connected to a first sensor 270 and a second sensor 370, a first motor 251 and a second motor 262 and a user interface control system 234, collectively referred to as “the peripheral devices.” The processor is capable of executing various programs to provide input to and/or receive outputs from the peripheral devices. Suitable processors for such use are known to those of skill in the art. In addition, the processor is operably connected to at least one memory storage device 281, such as a hard-drive or flash-drive or other suitable memory storage device.

Article dispensing machine memory storage device 281 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, article dispensing machine memory storage device 281 may incorporate electronic, magnetic, optical, and/or other types of storage media. Article dispensing machine memory storage device 281 can have a distributed architecture where various components are situated remote from one another, but are still accessed by processor. Article dispensing machine memory storage device includes an article dispensing machine database 282.

The article dispensing machines 230 preferably comprise a network of machines in communication with one another. As shown in FIG. 1, in the preferred configuration, the article dispensing machines 230 are networked with one another via a central server or central controller 302 in a hub-and-spoke system. However, optionally, the article dispensing machines may be connected and communicate directly with one another, and/or subsets of article dispensing machines may communicate with one another directly as well as with the central server 302.

Generally, in terms of hardware architecture, the central server 302 can include a central processor and/or controller, central memory, and one or more input and/or output (I/O) devices (or peripherals) that are communicatively coupled via a local interface. The architecture of the central server 302 is set forth in greater detail in U.S. Pat. No. 7,234,609, the contents of which are incorporated herein by reference. Numerous variations of the architecture of the central server 302 would be understood by one of skill in the art and are encompassed within the scope of the present invention.

The processor/controller is a hardware device for executing software, particularly software stored in memory. The processor can be any custom made or commercially available processor, a central processing unit (CPU), an auxiliary processor among several processors associated with the server 302, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. The processor may also represent a distributed processing architecture such as, but not limited to, SQL, Smalltalk, APL, KLisp, Snobol, Developer 200, MUMPS/Magic.

The software in memory may include one or more separate programs. The separate programs comprise ordered listings of executable instructions for implementing logical functions. The software in memory includes a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers, smartphones, or personal digital assistants (PDAs) (e.g., PalmOS available from Palm Computing, Inc., Windows CE or Windows Phone available from Microsoft Corporation, iOS available from Apple Inc, Android available from Google Inc., BlackBerry OS available from Research in Motion Limited, Symbian available from Nokia Corp.). The operating system essentially controls the execution of other computer programs and provides scheduling, input-output control, file and data management, memory management, and communication control and related services.

Steps and/or elements, and/or portions thereof of the present invention may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the operating system (O/S). Furthermore, the software embodying the present invention can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, Ada, and Lua.

When article dispensing machine 230 is in operation, the article dispensing machine processor is configured to execute software stored within article dispensing machine memory, to communicate data to and from the dispensing machine memory, and to generally control operations of article dispensing machine pursuant to the software. The software aspects of the present invention and the O/S, in whole or in part, but typically the latter, are read by processor, perhaps buffered within the processor, and then executed.

When the present invention or aspects thereof are implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

For communication with the central server 302, article dispensing machine 230 is equipped with network communication equipment and circuitry. In a preferred embodiment, the network communication equipment includes a network card such as an Ethernet card. In a preferred network environment, each of the plurality of article dispensing machines 230 on the network is configured to use the TCP/IP protocol to communicate via the network 301. It will be understood, however, that a variety of network protocols could also be employed, such as IPX/SPX, Netware, PPP, and others. It will also be understood that while a preferred embodiment of the present invention is for article dispensing machine 230 to have a “broadband” connection to the network 301, the principles of the present invention are also practicable with a dialup connection using a standard modem. Wireless network connections are also contemplated, such as wireless Ethernet, satellite, infrared, radio frequency, Bluetooth, near field communication, and cellular networks.

The central controller 302 communicates with the article dispensing machine controllers 300 via the network 301. The central controller 302 is preferably located at a central station or office that is remote from the plurality of article dispensing machines 230. The central controller 302 can operate as the server for communicating over the network 301 between the plurality of article dispensing machines 230. The central controller 302 receives communications and information from the article dispensing machines 230, and also transmits communications and information to the machines 230. For example, when a rental transaction is performed at the article dispensing machine 230, transaction data such as the rented title is then transmitted from the machine 230 to the central controller 302 via the network 301. It will be understood that central servers in general, such as the central controller 302, are often distributed. A plurality of central servers/controllers 302 may optionally be arranged in “load balanced” architecture to improve the speed and efficiency of the network. To accomplish the implementation of multiple controllers 302, the controllers 302 may be in communication with a router/distributor 303.

The central controller 302 is also in communication with a central database 304. The central database 304 stores information regarding the transaction network. For example, the central database 304 stores data regarding the vending inventory at each of the plurality of article dispensing machines 230. The central database 304 also stores sales information regarding the sales quantities of the vending merchandise stored in the machines 230. For example, the central database 304 stores information regarding the sales totals for each title and for each machine 230 vending location. Central database 304 also stores user information and rental transaction information, such as user IDs, the date on which discs are due to be returned, the date on which discs were rented from the machines 230 and a list of valid coupon codes and restrictions associated with those codes. In certain embodiments, central database 304 also may be configured to store user PINs. Some of this information is also preferably stored in article dispensing machine database 282.

Central database 304, which may include a ticketing database 358, is preferably a relational database, although other types of database architectures may be used without departing from the principles of the present invention. For example, the database 304 may be a SQL database, an Access database, or an Oracle database, and in any such embodiment have the functionality stored herein. Central database 304 is also preferably capable of being shared, as illustrated, between a plurality of central controllers 302 and its information is also preferably capable of being transmitted via network 301. It will be understood that a variety of methods exist for serving the information stored in central database 304. In one embodiment, .net and Microsoft Reporting Services are employed, however, other technologies such as ODBC, MySQL, CFML, and the like may be used.

The central controller 302 and central database 304 are also accessible by an electronic device 306, which may include a personal computer 102, mobile device 104 (e.g., smartphone, personal digital assistant, etc.), tablet computer 106, video game console 108, television 110, and Blu-Ray player 112. The electronic device 306 may be in direct or indirect communication with the central controller 302 and/or the central database 304 through a wired and/or wireless network connection, such as Ethernet, Wi-Fi, cellular (3G, 4G, etc.), or other type of connection. As a personal computer 102, the electronic device 306 will be understood as comprising hardware and software consistent with marketable personal and laptop computers, such as a display monitor, a keyboard, and a microprocessor. The electronic device 306 may also comprise Internet browser software such as Firefox, Internet Explorer, Chrome, or Safari. Using the browser software, a user of the electronic device 306 can access a website interface 360 through the central controller 302. An application may also execute on the electronic device 306 that accesses the central controller 302. To that end, central controller 302 preferably comprises web server software such as IIS or Apache. It will be understood that a variety of web server software and web browser software exists to implement the principles of the present invention without departing therefrom. Through the web browser software or application, the electronic device 306 communicates with the central controller 302 and allows the user to login to a central command functionality of the central controller 302 and to view and modify data stored in the central database 304. The browser interface or application also allows the user to perform certain system functions, which will affect the inventory and behavior of the article dispensing machines 230. The electronic device 306 may communicate with the central controller 302 and the central database 304 using rules and specifications of an application programming interface (API).

In a preferred embodiment, a financial server 305 is also in communication with the network 301. It will be understood that a variety of financial services exist for processing financial information via the Internet and other networks 301. Those services allow for the processing of credit card and debit card information, so that users of the services do not have to interface directly with credit and debit card companies. In FIG. 1, the financial server 305 is illustrated as a single server, although the financial server 305 may comprise an entire sub-network of financial servers 305 responsible for processing financial information.

As shown in FIG. 2, article dispensing machine 230 includes a machine housing 232 with front, rear, top, bottom, and side panels. The machine housing 232 is preferably a combination molded fiberglass and sheet metal cabinet. However, those skilled in the art will appreciate that the housing can be constructed from a variety of other suitable materials and with a variety of other suitable manufacturing techniques.

As shown most clearly in FIG. 2, a user interface portion 234 of housing 232 includes a card reader 240, a keypad and/or touch screen 242 and an article transfer opening 244. The card reader 240 is preferably designed in known fashion to read magnetically encoded membership and/or credit/debit cards for authorizing the distribution of articles of inventory through the article transfer opening 244. Keypad and/or touch screen 242 permits consumers and/or inventory stocking personnel to communicate with the dispensing machine 230 and/or a central office linked in electrical communication with the dispensing machine. Keypad and/or touch screen 242 also permits consumers and/or inventory stocking personnel to enter appropriate commands directed to carrying out specific machine tasks. It will be appreciated that the optional touch screen includes a monitor made with known technologies making it capable of being utilized as a user interface for entry of commands designed to carry out machine tasks. The touch screen 242 may also be capable of displaying a QR (Quick Response) code to a customer. The customer may read the QR code with a camera on a mobile device or with a dedicated QR code reader. The QR code can represent a universal resource locator (URL) to access a digital media selection, to represent a reference number for use by the customer when contacting customer service, or can be used to communicate a reminder notification for an event, for example.

Furthermore, it will be appreciated that additional user interface portions having additional or even identical user interface components could be incorporated within article dispensing machine 230. For example, these components could be incorporated on other panels of the housing 232 of machine 230 so that the machine can be used simultaneously by multiple consumers, translating into more efficient distribution of articles in high traffic areas. Dispensing machine 230 also preferably includes speaker units. Known audio technology may be incorporated within dispensing machine 230 to broadcast focused audio directed to relatively small (e.g., three square feet) locations in front of the machines from speaker units and/or in other designated locations at a retail site.

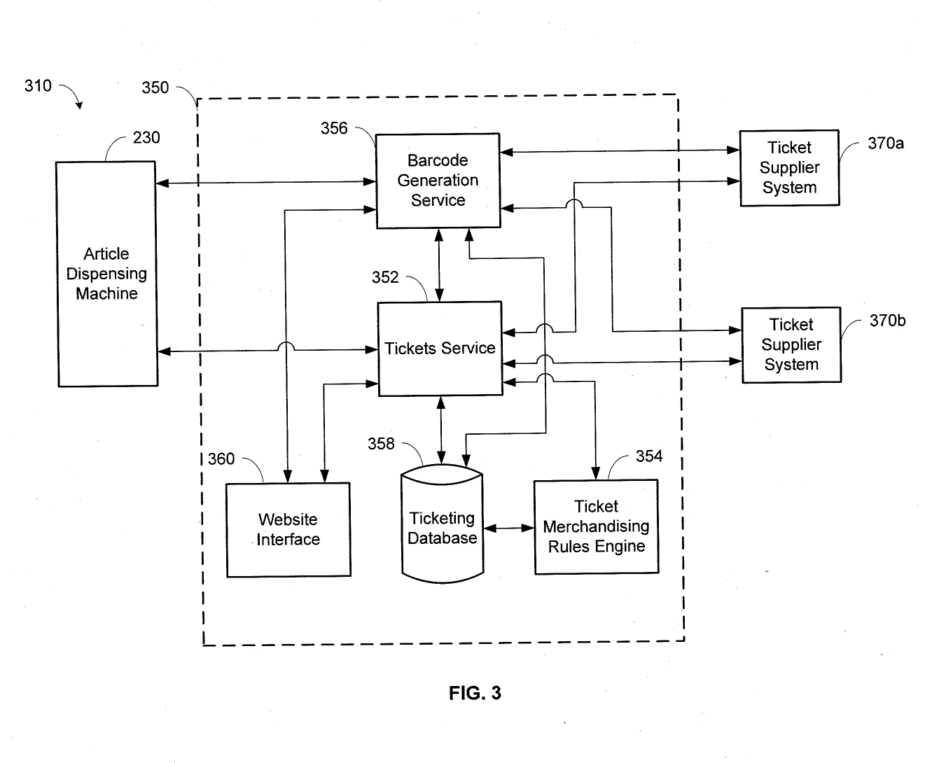

FIG. 3 illustrates a networked event ticketing system 310 including one or more article dispensing machines 230, an event ticketing management system 350, and ticket supplier systems 370a and 370b. The networked event ticketing system 310 provides for a variety of processes involving management, tracking, generation, and notification related to events, including processes related to the present invention. The networked event ticketing system 310 allows for direct and indirect communication between the components in the networked event ticketing system 310 via one or more networks. The components in the networked event ticketing system 310 may be operated by one or more entities. In one embodiment, the article dispensing machine(s) 230 and the event ticketing management system 350 are operated by a first entity, such as the operator of the article dispensing machines, while the ticket supplier systems 370a and 370b are operated by a second entity, such as a ticket supplier. A ticket supplier may include, for example, an event promoter, a venue, or other entity. In another embodiment, all of the components shown in the networked event ticketing system 310 of FIG. 3 are operated by the same entity.

Events may include at least sporting events, concerts, plays, musicals, movies, amusement parks, museums, and other attractions. Each event can include one or more productions, which are particular performances of the event at certain days, times, and/or venues. A ticket for an event may include a reserved seat ticket, a general admission ticket, a multi-day ticket, an open-ended ticket, and/or other type of ticket. The ticket supplier systems 370a and 370b can provide, publish, and allocate ticket inventory for any number of events and their associated productions to the event ticketing management system 350. The ticket inventory can include tickets that provide admission to and/or reserved seating at the events for holders of the tickets. Although FIG. 3 shows two ticket supplier systems 370a and 370b for simplicity, it is contemplated that any number of ticket supplier systems may be in communication with the event ticketing management system 350.

The event ticketing management system 350 includes components that can communicate information, such as ticket inventory availability and other data, to and from the article dispensing machines 230. Components in the event ticketing management system 350 also communicate information to and from the ticket supplier systems 370a and 370b. These components are described in further detail below. It will be understood that components 352, 354, 356 and 360 in the event ticketing management system 350 may be implemented, for example, by the central controller 302 using instructions stored in a memory connected to the central controller 302. It will be further understood that the ticketing database 358 may be implemented as part of the central database 304 or as a separate database.

The article dispensing machines 230 can communicate with the event ticketing management system 350, including the central server and controller 302, via network communication equipment and circuitry, as detailed above. Furthermore, the event ticketing management system 350 can communicate with the ticket supplier systems 370a and 370b via the same or different network communication equipment and circuitry. In particular, the event ticketing management system 350 can manage information regarding event ticketing between the ticket supplier systems 370a and 370b and the article dispensing machines 230. It will also be understood that while a preferred embodiment of the present invention is for the components of the system 310 to have a “broadband” connection with one another, the principles of the present invention are also practicable with a dialup connection using a standard modem. Wireless network connections are also contemplated, such as wireless Ethernet, satellite, infrared, radio frequency, Bluetooth, near field communication, and cellular networks.

Each of the article dispensing machines 230 may operate without requiring continuous connectivity and communication with the central controller 302. In one embodiment, the central controller 302 only transmits data in response to communication from an article dispensing machine 230. For example, an article dispensing machine 230 may attempt to communicate with the central controller 302 to query the ticketing database 358 regarding the availability of tickets for an event. In another embodiment, the article dispensing machine 230 continues normal operations and transactions even if communication is interrupted or cannot be established with the central controller 302. Communication with the central controller 302 may be interrupted if the load at the central controller 302 is above a certain threshold. For example, the central controller 302 may direct the article dispensing machine 230 to only transmit certain types of messages and/or transactions, e.g., financial authorizations, until the load has decreased. In these cases, transaction data can be stored locally in the article dispensing machine 230, such as in the article dispensing machine memory storage device 281, until a predetermined time interval elapses, when a predetermined number of transactions is reached, until communication with the central controller 302 can be reestablished, or the load at the central controller 302 has decreased. Once communication is established with the central controller 302, financial and inventory information can be uploaded and the appropriate servers and databases can be updated.

In a further embodiment, the article dispensing machine 230 may periodically communicate with the event ticketing management system 350 to add, delete, and/or update information related to events. For example, the article dispensing machine 230 may communicate with the event ticketing management system 350 on a regular basis at predefined intervals, e.g., every three hours, to ensure that the article dispensing machine 230 has the most relevant and up-to-date information regarding events. The information related to events may include event details (e.g., descriptions), event artwork, categories, production dates and times, venue, age ratings, reviews, and/or other information. The events available for transactions at the article dispensing machines 230 can be derived from prospective events. The event ticketing management system 350 can review the prospective events to determine whether a particular prospective event and/or its associated productions should be included in a listing of events at the article dispensing machines 230.

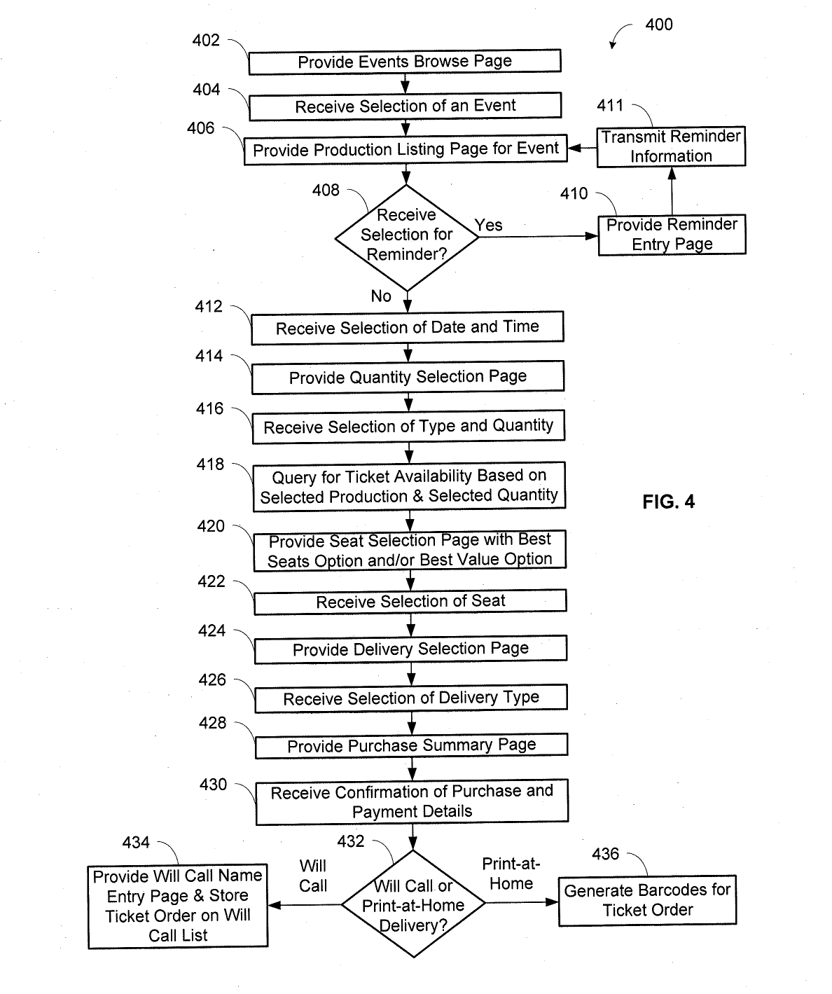

A tickets service 352 in the event ticketing management system 350 can be configured to communicate with the article dispensing machine 230 and the ticket supplier systems 370a and 370b. The tickets service 352 can be accessed during a ticket order transaction through the article dispensing machine 230 and/or the website interface 360. The ticket order transaction can be completed using a series of interface pages on a user interface 234 of the article dispensing machine 230, for example. By using the series of interface pages, a user of the article dispensing machine 230 may quickly and easily complete a ticket order transaction independently without the need for external assistance. By requiring the user to make a minimal number of decisions on each of the interface pages, the user's experience with the ticket order transaction may be simplified. An embodiment of a process 400 for managing a ticket order transaction at an article dispensing machine 230 is shown in FIG. 4, and is described below. It should be noted that each of the interface pages may comply with the Americans with Disabilities Act and other applicable laws, rules, and regulations. For example, pertinent selectable buttons may be positioned on the bottom portion, e.g., bottom two-thirds, of each of the interface pages.

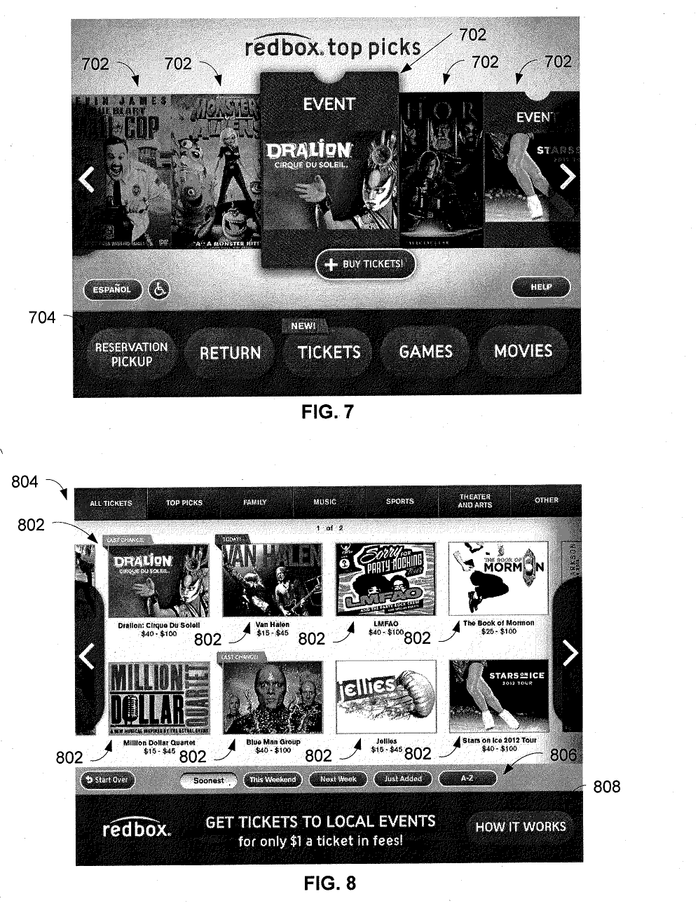

A user can utilize the article dispensing machine 230 to perform transactions related to renting or purchasing media articles (e.g., DVDs, Blu-Ray discs, and video game discs), digital media selections (e.g., streaming, downloadable, and on-demand media), and event ticketing. To enable such transactions, a merchandising page, such as illustrated in FIG. 7, can be displayed on the user interface 234. The merchandising page may be configured as a “carousel” such that artwork and/or descriptions for the merchandise 702, i.e., media articles, media selections, and/or event ticketing, can be dynamically displayed. Each displayed piece of merchandise can be selected by a user on the user interface 234 to begin a transaction involving the piece of merchandise. In one embodiment, the merchandising page may be initially displayed on the user interface 234, prior to any user interaction with the article dispensing machine 230.

The “carousel” may periodically change so that multiple pieces of merchandise can be displayed for periodic intervals. Certain pieces of merchandise can be enlarged or otherwise highlighted, such as the displayed piece of merchandise in the center of the user interface 234. For example, the event “Dralion Cirque du Soleil” is highlighted for ticketing in FIG. 7. In some embodiments, the quantity of certain types of merchandise can be limited so that not all of the displayed pieces of merchandise are of the same type. The types of merchandise can also be alternated so that pieces of merchandise of the same type are not necessarily displayed next to one another. Instead of selecting a displayed piece of merchandise to begin a transaction, a user may also select an appropriate button 704 to browse the particular type of merchandise, e.g., tickets, games, or movies. Other buttons 704 may be available on the merchandising page to return media articles or perform reservation pickups, for example.

If the tickets button is accessed to browse for event tickets, an events browse page, such as illustrated in FIG. 8, can be displayed on the user interface 234 at step 402 of the process 400. The events browse page can include selectable listings 802 of one or more events that are available for ticketing at the article dispensing machine 230. The selectable listings can each include event artwork, an event title, an event description, a ticket price range, an average ticket price, and/or other information. The selectable listings on the events browse page may be curated by the tickets service 352 for the particular article dispensing machine 230, as described further below. An event may include one or more main events, one or more sub-events, and/or one or more venues that could be presented as selectable listings 802. A ticket order transaction may involve the purchase of a ticket to the main event(s) and/or the sub-event(s) at the venue(s). A selectable listing can be displayed with a flag to highlight and showcase the listing, such as if the event is today (“Today!”), ending soon (“Last Chance!”), and/or for other reasons. In some embodiments, certain events can be manually designated as a “Top Pick” so that these events are highlighted and showcased. An event designated as a “Top Pick” may include major events, such as events involving professional sports teams and popular musicians, for example.

A user can sort and filter the selectable listings of events on the events browse page by selecting a category button 804. For example, if the sports category button is selected, the events browse page may display only events related to sports. The user can also sort and filter the selectable listings of events on the events browse page by selecting a button 806 relating to the date range (e.g., soonest, this weekend, next week, etc.), price, alphabetical order (e.g., A-Z), or other criteria. In some embodiments, a text entry field (not shown) can be displayed on the events browse page so that a user can directly search for a specific event and/or production. A selectable button 808 may also be included on the events browse page to allow the user to access a tutorial page (not shown) describing how to utilize the article dispensing machine 230 for a ticket order transaction.

In certain embodiments, the selectable listings 802 on the events browse page can be based on a transaction history of the user of the article dispensing machine 230. The transaction history may include the rental or purchase history of a media article or media selection, for example, such that the selectable listings 802 of events can be related to one or more rentals or purchases. In one embodiment, if the user enters a unique customer identifier at the user interface 234 of the article dispensing machine 230, such as by swiping a credit card or debit card, the article dispensing machine 230 may query the tickets service 352 to retrieve the transaction history of the user. Based on the transaction history, the article dispensing machine 230 can determine which events to display in the selectable listings 802. Certain events may also be highlighted and showcased, based on the transaction history. For example, if the user has previously rented or is currently renting the movie “Cinderella”, one of the selectable listings 802 of an event that is shown, highlighted, or showcased may be “Disney Stars on Ice”. Other pieces of merchandise may also be highlighted or showcased based on a ticket order transaction. For example, if the user purchases tickets to an NFL football game, the video game Madden NFL and/or a DVD for NFL Football Follies may be highlighted or showcased. The selection of a particular event on the events browse page can be received by the article dispensing machine 230 at step 404.

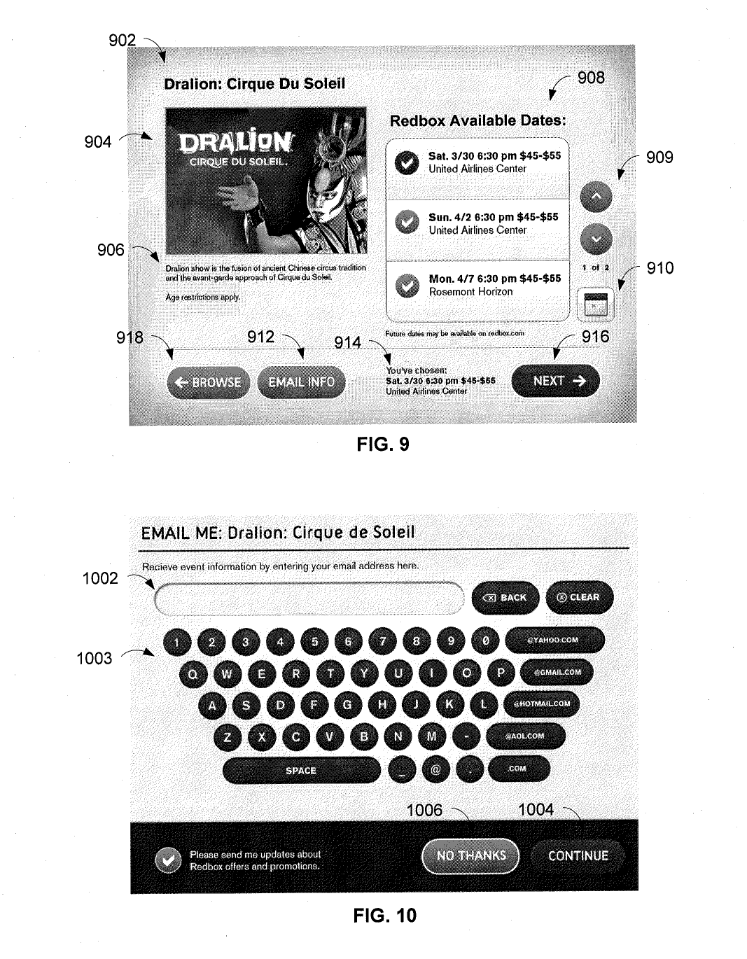

A production listing page for a particular event, such as illustrated in FIG. 9, can be displayed on the user interface 234 at step 406 when a selectable listing 802 for the particular event is selected from the events browse page and received at step 404. The production listing page for a particular event may also be displayed on the user interface 234 if the particular event is selected from the merchandising page. The production listing page may include the event name 902, event artwork 904, an event description 906, and a production listing 908. The event description 906 may include a description of the event and/or whether there are any applicable age restrictions for admission to the event. If an event with an age restriction is selected, an age restriction warning page (not shown) may be displayed on the user interface 234 so that the user can acknowledge that there is an age restriction for the event. The event description may also include information on any secondary acts, such as an opening act for a concert.

The production listing 908 can include selectable listings for one or more productions at their respective dates, times, and venues for when the particular event is to be performed and for which tickets are available. The venues for a particular production and/or a particular event may vary, in some cases. The price ranges and/or average price of the available tickets for each of the productions can also be included in the production listing 908. If more production listings 908 are available than can be shown at one time, pagination buttons 909 can be selected to access the additional production listings 908. A selectable calendar view button 910 may be selected on the production listing page to list the productions in a calendar format for selection by the user. The calendar format may include a daily, weekly, and/or monthly format that shows the production listings. If one of the selectable listings is selected by a user on the user interface 234, a current selection 914 can be displayed that includes information regarding which of the selectable listings has been selected. The selected production listing 908 can also be highlighted, such as with a colored checkmark, for example. The production listing page can also include a next or continue button 916 to continue with the ticket order transaction, or a browse or back button 918 to return to the events browse page. The selection of a particular production on the production listing page can be received by the article dispensing machine 230 at step 412, if a reminder button 912 is not selected at step 408.

The production listing page may further include a reminder button 912 (shown as “email info”) that can be selected on the user interface 234 at step 408. If selected, the reminder button 912 can result in the display of a reminder entry page at step 410, such as illustrated in FIG. 10, on the user interface 234. The reminder entry page can include a communication input field 1002 for allowing the user to input an email address, phone number, or other communication address. The user may enter the communication address with an on-screen keyboard 1003, hardware keyboard, or other input device. When completed, the reminder entry page can cause the article dispensing machine 230 or the tickets service 352 to transmit a reminder notification to the communication address via email, SMS/text messaging, or other medium. The reminder notification can include the event information and/or a URL to the website interface 360 to continue the ticket order transaction. For example, the user may select the reminder button 912 to receive the reminder notification and complete the ticket order transaction later, such as if the user wishes to consult with other persons about the event. Once the communication input field 1002 is completed, a continue button 1004 can be selected to transmit the reminder at step 411 and then return to displaying the production listing page at step 406. If the user does not wish to utilize the reminder entry page, a no thanks button 1006 can be selected to return to the production listing page.

In some embodiments, a tracking identifier can be stored when a reminder notification is transmitted. The tracking identifier can uniquely identify the particular article dispensing machine 230, the ticket order transaction, a partner associated with the article dispensing machine 230 (e.g., the retailer where the article dispensing machine 230 is located), and/or other information. This information can be used to assist the user in completing the ticket order transaction on a different platform other than the article dispensing machine 230, e.g., the website interface 360. This information can also be used to properly attribute a completed ticket order transaction to the particular article dispensing machine 230 and/or the partner, in accordance with contractual agreements.

In certain embodiments, the production listing page may not be displayed on the user interface 234 at step 406 when a selectable listing 802 for the particular event is selected from the events browse page and received at step 404. Instead, the quantity selection page, described below, may be displayed following the selection of a selectable listing 802 on the events browse page. For example, the selectable listing 802 may include admission to a museum, amusement park, or other attraction that is not specific to any particular date and time. The ticket resulting from a ticket order transaction involving such an admission can be an event voucher, pass, or similar ticket that allows the bearer to redeem the ticket on any date and/or time. In this case, the ticket may have an expiration date, such as one year from issuance.

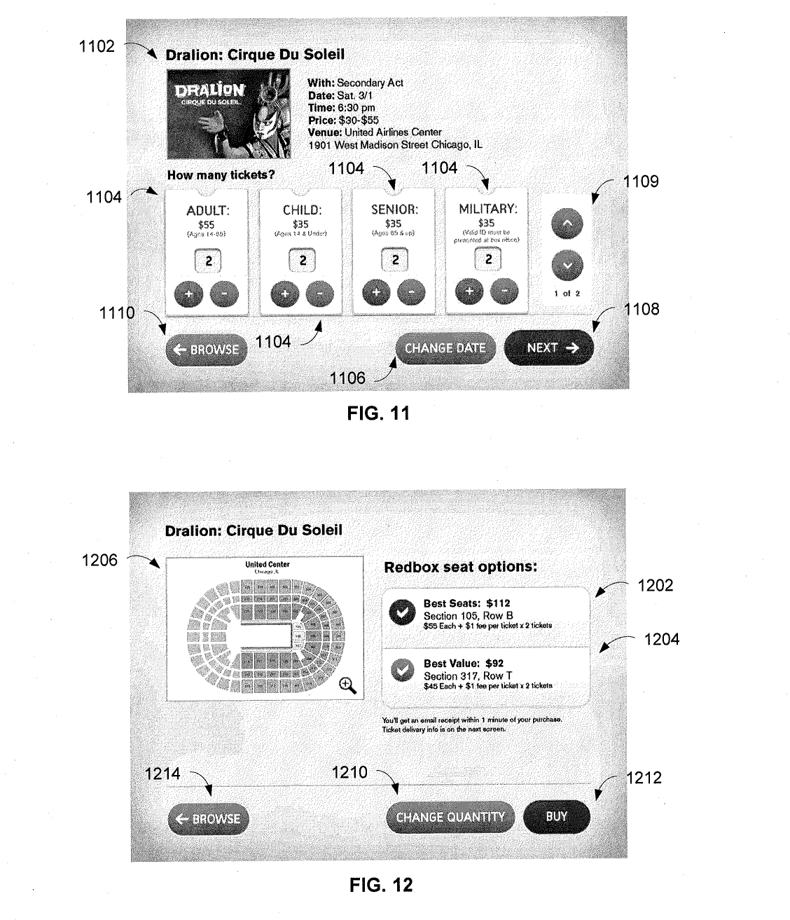

A quantity selection page, such as illustrated in FIG. 11, can be displayed on the user interface 234 at step 414 when a particular desired production has been selected on the production listing page at step 412. The quantity selection page can include production information 1102 (e.g., date, time, price ranges, average price, venue, event artwork, etc.) and one or more ticket quantity input elements 1104. A ticket quantity input element 1104 can be displayed for each type of ticket group (e.g., adult, child, senior, military, etc.) for the event and the associated production. A type of ticket group can also include ticket packages with add-ons to the tickets, e.g., parking passes, food packages, etc. If more types of ticket groups are available than can be shown at one time, pagination buttons 1109 can be selected to access additional ticket quantity input elements 1104 for the additional types of ticket groups. The user can specify the desired quantity of tickets for each type of ticket group for the desired production using the ticket quantity input elements 1104. The desired quantity can be limited to minimum and/or maximum quantities, based on contractual obligations or other factors. The ticket quantity input elements 1104 can include increment and decrement buttons, as shown, and/or may include direct numerical entry of the desired quantity. The quantity selection page can also include a next or continue button 1108 to continue with the ticket order transaction, a browse or back button 1110 to return to the events browse page, and/or a change date button 1106 to return to the production listing page. The selection of a desired quantity and type of ticket group on the quantity selection page can be received by the article dispensing machine 230 at step 416.

After the quantity selection page is completed at step 416, the article dispensing machine 230 can access the tickets service 352 at step 418 to retrieve a ticket availability, based on the desired quantity entered on the quantity selection page for the desired production. The article dispensing machine 230 may access the tickets service 352 to query the ticketing database 358 and/or the pertinent ticket supplier system 370a and 370b at step 418 in real-time to determine whether tickets for the desired production are available at the desired quantity. The tickets service 352 can return the ticket availability to the article dispensing machine 230. If the article dispensing machine 230 is not able to access the tickets service 352, e.g., if there is no network availability, then the tickets order can be cancelled and an error page can be displayed on the user interface 234.

A seat selection page, such as illustrated in FIG. 12, can be displayed on the user interface 234 at step 420 and can include the ticket availability received at step 418. The ticket availability may include a best seats option 1202 and/or a best value option 1204. Each of the best seats option 1202 and the best value option 1204 may include the section, row, seat, and/or other seat location information, as well as the quantity of tickets in the ticket order transaction, the price of the tickets, and/or total price of the ticket order transaction. The best seats option 1202 may be the highest ranking available ticket, which can be determined by whether the corresponding seats are closest to the stage, court, field, etc., for example, regardless of ticket price. The particular seats (and their section, row, etc.) may have been previously assigned a particular ranking based on objective and/or subjective information regarding the enjoyment and satisfaction of spectators in the particular seats for the event or venue. For example, seats closer to the stage for concerts or to the field for baseball games may have a higher ranking that seats farther away from the stage or field. In some embodiments, the best seats option 1202 may include seats with the largest available inventory, if the only available tickets are at the same price.

The best value option 1204 may be the lowest price available ticket, regardless of seat location. In some embodiments, the best value option 1204 may take into account the ranking of the seat location. In other embodiments, more than one best seat option 1202 and/or more than one best value option 1204 may be displayed on the seat selection page. For example, if the only available seats for a production are at one price, then multiple best seat options 1202 can be displayed where the primary best seat option 1202 has a higher ranking and the secondary best seat option 1202 has a lower ranking.

The seat selection page can also include a venue map 1206 for assisting the user in identifying the location in the venue of the sections, rows, etc. of the available tickets. The venue map 1206 may be zoomable and/or interactive so that details of the seating locations can be discerned. A selectable venue info button 1208 can also be selected to display further detailed information about the venue, such as location, travel directions, public transportation information, box office times, etc. The seat selection page can also include a next or continue button 1212 to continue with the ticket order transaction, a browse or back button 1214 to return to the events browse page, and/or a change quantity button 1210 to return to the quantity selection page. In some embodiments, the seat selection page can include an interactive seat map configured to allow the user to select an available seat, section, row, etc. The selection of a seat on the seat selection page can be received by the article dispensing machine 230 at step 422.

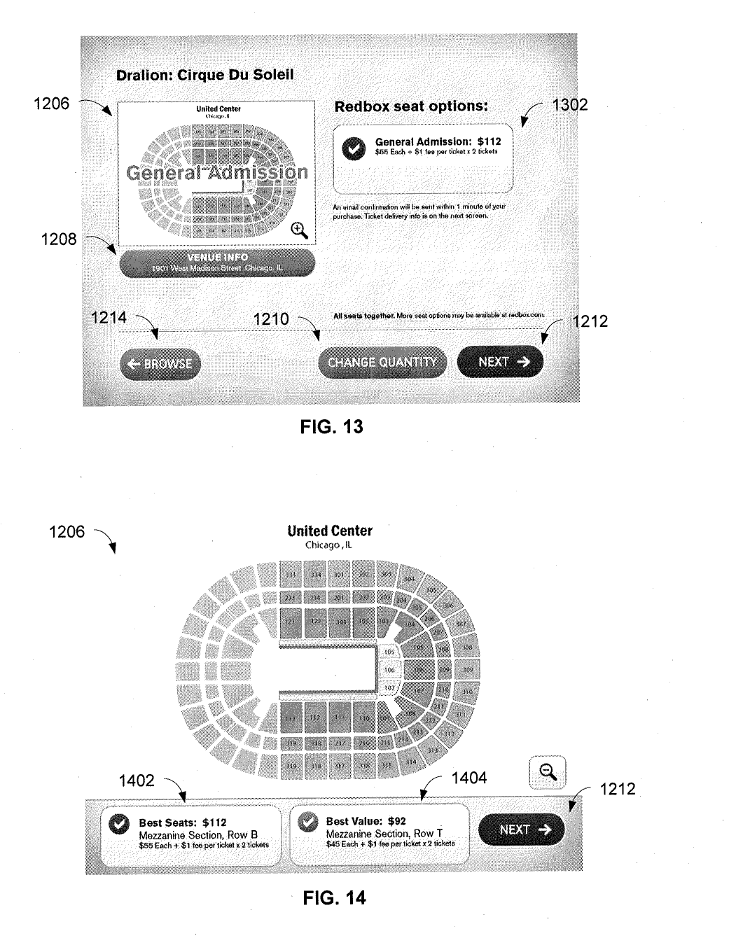

FIGS. 13 and 14 illustrate alternative seat selection pages that can be displayed on the user interface 234 at step 420. Each of FIGS. 13 and 14 can include the ticket availability, as described above. In particular, the ticket availability shown in FIG. 13 is related to general admission ticket option 1302 that does not have a specific seat, section, row, etc. In this case, there may be only one selectable option for the user on the seat selection page. The ticket availability shown in FIG. 14 is similar to that shown in FIG. 12, described above, but is arranged differently on the seat selection page. A best seats option 1402 and a best value option 1404 are shown, and the venue map 1206 is larger in FIG. 14 than in FIG. 12.

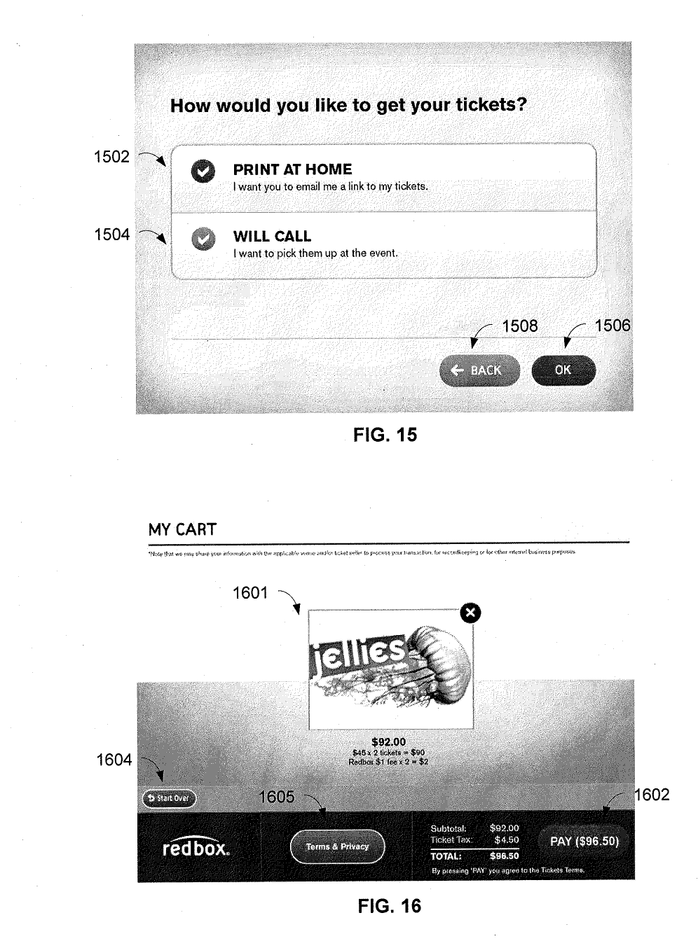

Following the selection of seats on the seat selection page at step 422, the article dispensing machine 230 can display a delivery selection page on the user interface 234 at step 424, as illustrated in FIG. 15. The delivery selection page can allow the user to select how the tickets from the ticket order transaction are to be delivered to the user. In FIG. 15, a print-at-home option 1502 and a will call option 1504 are shown, but other delivery options are contemplated, such as mobile device delivery, Flash Seats, and Apple Passbook. If selected, the print-at-home option 1502 allows the user to later print the tickets of the ticket order transaction on a printer, for example. The will call option 1504 allows the user to pick up the tickets for the production at the venue. The delivery selection page can also include an ok button 1506 to continue with the ticket order transaction and a back button 1508 to return to the seat selection page. The selection of a delivery option on the delivery selection page can be received by the article dispensing machine 230 at step 426.

A purchase summary page, such as illustrated in FIG. 16, can be displayed on the user interface 234 at step 428 following the selection of a delivery option on the delivery selection page at step 426. The purchase summary page can include a summary 1601 of the ticket order transaction, such as event details (e.g., description, date, time, venue, artwork, etc.), ticket prices, total prices, taxes, fees, and/or other information. A pay button 1602 can be selected on the purchase summary page to complete the ticket order transaction. The purchase summary page can also include a start over button 1604 to cancel the current ticket order transaction and start a new ticket order transaction. A terms and privacy button 1605 may also be included on the purchase summary page so that the user can access terms and conditions and/or the privacy policy relating to the ticket order transaction. Payment pages (not shown) may also be displayed on the user interface 234 at step 428 to receive payment at step 430 from the user at the article dispensing machine 230. Payment from the user may include charging the total price of the ticket order transaction to a credit card or a debit card, redeeming credits, promotion codes, and/or gift cards, utilizing electronic payments (e.g., Google Wallet, PayPal, etc.), group ticket purchasing, and/or other payment methods. In the case of charging a credit card or a debit card, the user may need to enter a zip code for the billing address of the credit card or debit card to process the payment. The article dispensing machine 230 may utilize the financial server 305, for example, to process the payment.

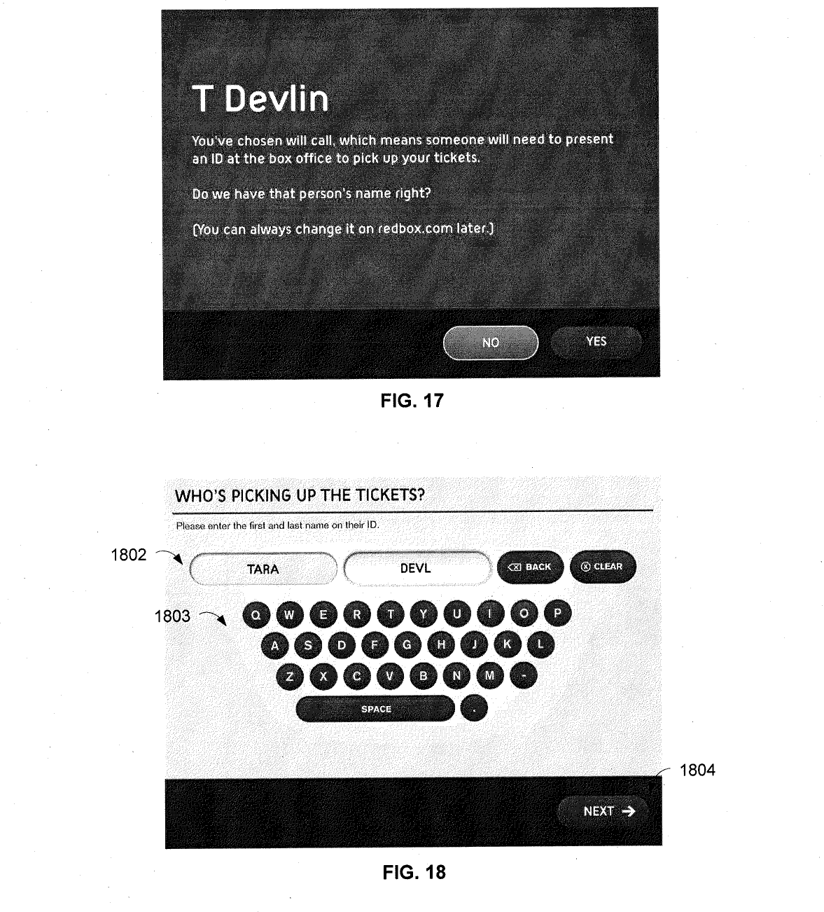

If the will call option 1504 was selected on the delivery selection page at step 432, one or more will call name entry pages, such as illustrated in FIGS. 17 and 18, can be displayed on the user interface 234 at step 434. The will call name entry pages can be initially populated with a name derived from the payment information, for example, as shown in FIG. 17. However, because the person who purchased the tickets does not necessarily have to be the same person who picks up the tickets at the venue, the name of the person who will be picking up the tickets can be entered in a name entry field 1802, as shown in FIG. 18. The user may enter a name in the name entry field 1802 with an on-screen keyboard 1803, hardware keyboard, or other input device. Generally, the person picking up the tickets at the venue will need to show an identification card (e.g., driver's license, school identification card, etc.) that matches the name entered on the will call name entry page, in order to pick up the tickets. The completion of the will call name entry page can result in storing the ticket order transaction on a will call list at step 434. The will call list can be stored in the ticketing database 358 and/or transmitted to the pertinent ticket supplier system 370a and 370b.

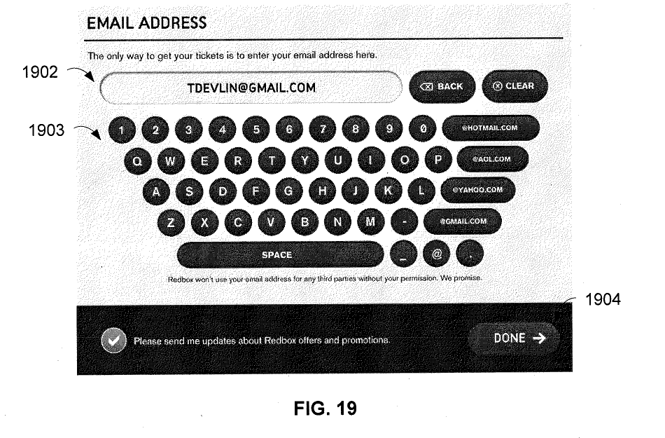

Following completion of the will call name entry page at step 434, or if the print-at-home option 1502 was selected on the delivery selection page, the article dispensing machine 230 can display an order confirmation communication page on the user interface 234, as shown in FIG. 19. The order confirmation communication page can include a communication input field 1902 for allowing the user to input an email address, phone number, or other communication address. The user may enter the communication address with an on-screen keyboard 1903, hardware keyboard, or other input device. A done button 1904 can be selected on the user interface 234 to denote completion of the order confirmation communication page and the ticket order transaction. Completion of the order confirmation communication page can cause the article dispensing machine 230 or the tickets service 352 to transmit a ticket order confirmation related to the ticket order transaction to the communication address via email, SMS/text messaging, or other medium. The tickets service 352 may also transmit the information related to ticket order transaction to the pertinent ticket supplier system 370a and 370b at steps 434 or 436, as applicable. The information related to the ticket order transaction may include, for example, the locations of the seats, barcode information, and/or will call information (if applicable) so that the ticket supplier and/or the venue is informed of the sale of tickets to the production of the event. In this way, the ticket supplier system 370a and 370b and/or the venue will know to admit the bearers of the tickets when the ticket is presented at the production of the event. In addition, the tickets service 352 may store some or all of the information related to the ticket order transaction in the ticketing database 358. In the case of the print-at-home delivery option, the barcode information may be generated at step 436 prior to being transmitted to the pertinent ticket supplier system 370a and 370b.

A barcode generation service 356 in the event ticketing management system 350 can be configured to communicate with ticket service 352. In some embodiments, the barcode generation service can be configured to communicate with the article dispensing machine 230 and the ticket supplier systems 370a and 370b. The barcode generation service 356 can be accessed following a ticket order transaction that has been performed through the article dispensing machine 230 and/or the website interface 360. In particular, if the ticket order transaction includes the print-at-home option or printing of the tickets on the article dispensing machine 230, a ticket barcode for each of the tickets of the ticket order transaction may be generated at step 436. The ticket barcodes for the tickets may conform to the requirements of the venue for the production of the event. After ticket barcodes for the tickets are generated, the barcode generation service 356 may transmit the ticket barcodes to the pertinent ticket supplier system 370a and 370b so that the ticket supplier and/or the venue is informed of the barcodes for admission control purposes. Further details of the barcode generation service 356 are described in a concurrently filed patent application entitled “System and Method for Dynamic Barcode Generation Related to Event Ticketing”, Attorney Docket Number 019638.32US1, which is herein incorporated by reference in its entirety.

The tickets service 352 can also operate in conjunction with a ticket merchandising rules engine 354 to curate a listing of events for ticket ordering at the article dispensing machine 230. The ticket merchandising rules engine 354 can review prospective events to derive the listing of events. Some or all of the listing of events can be displayed on the article dispensing machine 230, such as on the merchandising screen and/or the events browse screen, as described above. For example, the listing of events may include a larger quantity of events, e.g., 120 events, than will actually be shown on the article dispensing machine 230 at a given time, e.g., 80 events. In this way, if an event that is initially shown on the article dispensing machine 230 exhausts its ticket inventory, another event that was not previously shown can then be shown. The listing of events can be curated based on the location of the article dispensing machine 230, the priority ranking of the event, the date and time of the productions, the category of the events, the location of the venue relative to the article dispensing machine 230, and/or other factors.

For a particular article dispensing machine 230, a hyper-local listing of events can therefore be curated so that users of the article dispensing machine 230 can view, browse, and purchase tickets to the events that are mostly likely relevant to the users. Each article dispensing machine 230 can have a unique listing of events that can change based on the date, time, location, and/or other factors. For example, an article dispensing machine 230 may be located at a grocery store. During the day, when it is more likely that families with children are shopping at the grocery store, the curated listing of events for the article dispensing machine 230 may include more family-oriented events. However, in the evening, it may be more likely that professionals leaving work may be shopping at the grocery store. In this case, the curated listing of events for the article dispensing machine 230 may include more nightlife events, e.g., comedy shows, theatre, etc.

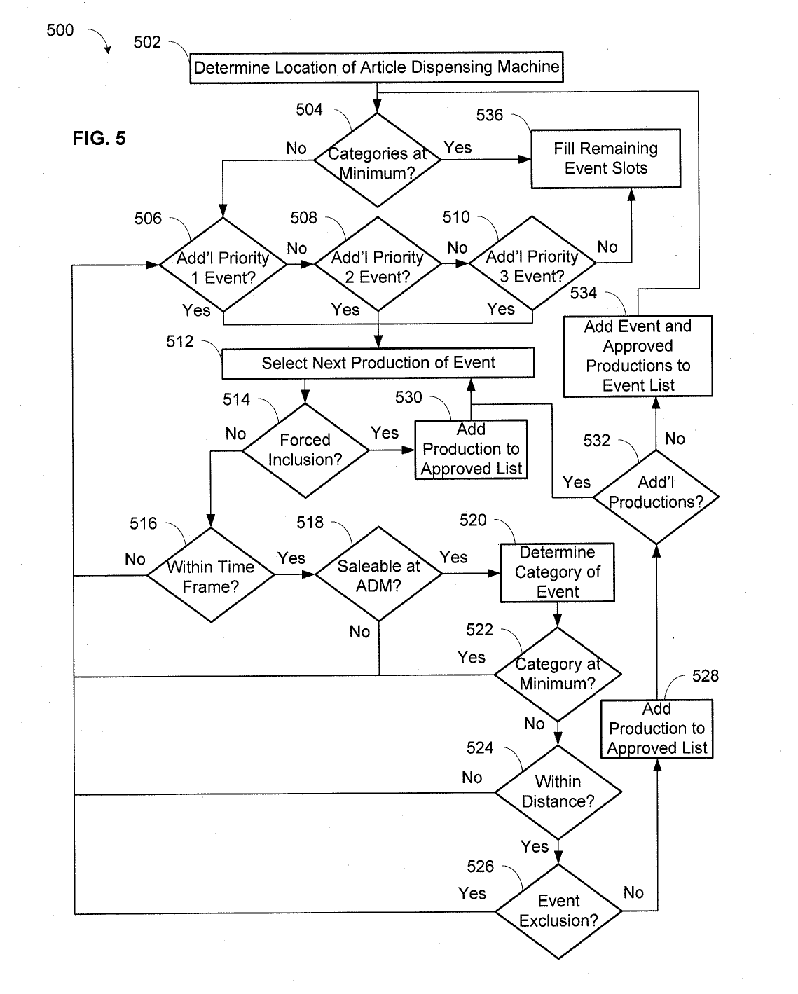

An embodiment of a process 500 for curating the listing of events available for ticket ordering at an article dispensing machine 230 is shown in FIG. 5. At step 502, the location of the article dispensing machine 230 can be determined. The location of the article dispensing machine 230 may have been stored in a central database 304 or obtained from the article dispensing machine 230, and can be based on a zip code, latitude and longitude, address, a time zone, IP address, retailer account information (e.g., the location of a particular store of the retailer where the article dispensing machine 230 is located), and/or other location information. At step 504, it is determined whether each of the categories for the listing of events has reached a minimum threshold of events. The minimum threshold may be predetermined and static, or may be dynamically determined. For example, the minimum threshold may be eight events per category. Accordingly, at step 504, if each of the categories is not yet at the minimum threshold, then the process 500 can continue to step 506. However, if each of the categories is at the minimum threshold at step 504, then the process 500 can continue to step 536 to fill any remaining event slots in the listing of events. Step 536 is described further below.

At step 506, it can be determined whether any prospective events with an assigned priority of 1 (e.g., the highest priority) have been considered yet. If there are prospective events with an assigned priority of 1, then the process 500 can continue to step 512 to select a next production of the particular prospective event. However, if there are not prospective events with an assigned priority of 1, then the process 500 can continue to step 508 to determine whether any prospective events with an assigned priority of 2 (e.g., the next highest priority) have been considered yet. If there are prospective events with an assigned priority of 2, then the process 500 can continue to step 512 to select a next production of the particular prospective event. However, if there are not prospective events with an assigned priority of 2, then the process 500 can continue to step 510 to determine whether any prospective events with an assigned priority of 3 (e.g., the lowest priority) have been considered yet. If there are prospective events with an assigned priority of 3, then the process 500 can continue to step 512 to select a next production of the particular prospective event. If there are no unconsidered prospective events with an assigned priority of 3, then the process 500 can continue to step 536 to fill any remaining event slots in the listing of events. It should be noted that any number of assigned priorities are possible for the prospective events, and that three levels of assigned priorities is merely exemplary.

If a prospective event exists for consideration, then it can be referred to as an event under consideration. At step 512, a next production of the event under consideration can be selected for review. The next production of the event under consideration may include the production with a date and time that is soonest to the current date and time. In some embodiments, the next production of the event under consideration that is selected for review may be based on available ticket types (e.g., open-ended, multi-day passes, etc.), marketing promotions, and/or other factors. At step 514, it can be determined whether a forced inclusion flag has been set for the next production. The forced inclusion flag may denote that the next production must be included in an approved list of productions for the associated event. The forced inclusion flag may be manually or automatically set based on objective and/or subjective criteria. For example, an event with a set forced inclusion flag may be included as a “Top Pick”, as described above. As another example, if it is desired to always include sporting events related to a major professional sports team at all article dispensing machines 230 in a certain geographical area regardless of the distance between the article dispensing machines 230 and the venue, then the forced inclusion flag for productions of such sporting events may be set. As a further example, many persons in the Los Angeles may be interested in events in Las Vegas. Therefore, events in Las Vegas may have their forced inclusion flag set so that these events are included in article dispensing machines 230 located in the Los Angeles area. If the forced inclusion flag is set at step 514, then the next production may be added to the approved list of productions at step 530. The process 500 may then return to step 512 to select a next production of the event under consideration. However, if the forced inclusion flag is not set at step 514, the process 500 may continue to step 516.

At step 516, it may be determined whether the next production is within an upcoming timeframe of the current date and time. The upcoming timeframe may be predetermined and static, or may be dynamically determined. For example, the upcoming timeframe may be within a maximum of three weeks of the current date and time. The upcoming timeframe may be considered in one or more increments up to a maximum timeframe. For example, if the next production of the event under consideration is within one week in an iteration, it may be considered to be within the upcoming timeframe. As another example, if the next production of the event under consideration is within three weeks in another iteration, it may be considered to be within the upcoming timeframe. If the next production is not within the upcoming timeframe at step 516, then the process 500 may discard the event under consideration from further review and return to step 506 to determine another event under consideration. In other words, because the next production of the event under consideration does not meet the particular criteria, the associated event under consideration may be excluded from further review. If the next production is within the upcoming timeframe at step 516, then the process 500 may continue to step 518.

It may be determined at step 518 whether the next production is saleable at the article dispensing machine 230. Whether the next production or the event under consideration is saleable may be based on the ability for such tickets to be sold at the article dispensing machine 230, and may be based on an initial ticket allotment from the pertinent ticket supplier. For example, one or more flags in the ticketing database 358 can be set manually or automatically, and denote whether a particular production and/or event is desired to be displayed at a particular consumer channel, such as an article dispensing machine 230, the website interface 360, email, mobile, or other channel. The flags in the ticketing database 358 may also include whether the production and/or event is active for ticketing sales or inactive for ticketing sales. If the next production is not saleable at step 518, then the process 500 may discard the event under consideration from further review and return to step 506 to determine another event under consideration. If the next production is saleable at step 518, then the process 500 may continue to step 520.

At step 520, the category of the event under consideration may be determined. An event may be classified under more than one category, but a primary category may be assigned to the event. The category of the event may include, for example, sports, family, theater, arts, music, and other categories. After determining the category of the event under consideration, it can be determined at step 522 whether the particular category has reached a minimum threshold. The minimum threshold may be predetermined and static, or may be dynamically determined. For example, the minimum threshold may be eight events per category. If the category for the event under consideration has reached the minimum threshold at step 522, then the process 500 may discard the event under consideration from further review and return to step 506 to determine another event under consideration. However, if the category for the event under consideration has not reached the minimum threshold at step 522, then the process 500 may continue to step 524.

It may be determined at step 524 whether a location of the next production of the event under consideration is within a proximity of the location of the article dispensing machine 230. The location of the article dispensing machine 230 may have been previously determined at step 502. The proximity of the locations for a next production may be considered in one or more increments up to a maximum distance over one or more iterations. For example, at step 524, locations of the next production of the event under consideration that are within five miles of the location of the article dispensing machine 230 may be considered to be within the proximity in an iteration. As another example, locations of the next production of the event under consideration that are within twenty-five miles of the location of the article dispensing machine 230 may be considered to be within the proximity in another iteration. The proximity, increments, and/or the maximum distance may be variable, based on factors such as metropolitan area, demographics, and other factors.

The proximity and the upcoming timeframe, described in relation to step 516, may be considered simultaneously when a next production of an event under consideration is being reviewed using the process 500. In particular, the increments of each of the proximity and the upcoming timeframe may be taken into account when deciding whether to include a next production in the listing of events. For example, the proximity may be set to five miles while the upcoming timeframes are incremented from one week to two weeks to three weeks. In a next iteration, the proximity may be set to ten miles and the upcoming timeframes again incremented from one week to two weeks to three weeks. In this way, the most hyper-localized and relevant events may be included in the listing of events for a particular article dispensing machine 230. If the location of the next production is not within the proximity of the location of the article dispensing machine 230 at step 524, then the process 500 may discard the event under consideration from further review and return to step 506 to determine another event under consideration. If the location of the next production is within the proximity of the location of the article dispensing machine 230 at step 524, then the process 500 may continue to step 526.

At step 526, it may be determined whether the event under consideration satisfies one or more exclusion criteria associated with a ticket ordering allowability. The exclusion criteria may be based on contractual obligations, legal requirements, and/or other factors. For example, sporting events related to a professional sports team may not be offered in the market of a competing professional sports team, based on geographic area or other considerations. In this example, the event under consideration may satisfy the exclusion criteria at step 526. If the event under consideration satisfies the exclusion criteria at step 526, then the process 500 may discard the event under consideration from further review and return to step 506 to determine another event under consideration. However, if the event under consideration does not satisfy the exclusion criteria at step 526, then the process 500 may continue to step 528.

At step 528, the next production of the event under consideration may be added to the approved list of productions for the event. It may be determined at step 532 whether there are additional productions for the event under consideration. If there are additional productions for the event under consideration, then the process 500 may return to step 512 to select a next production of the event under consideration. However, if there are not additional productions for the event under consideration at step 532, then at step 534, the event under consideration and the approved list of productions for the event under consideration may be added to the listing of events for the article dispensing machine 230. The process 500 may return to step 504 following step 534 to determine whether each of the categories for the listing of events has reached a minimum threshold of events.

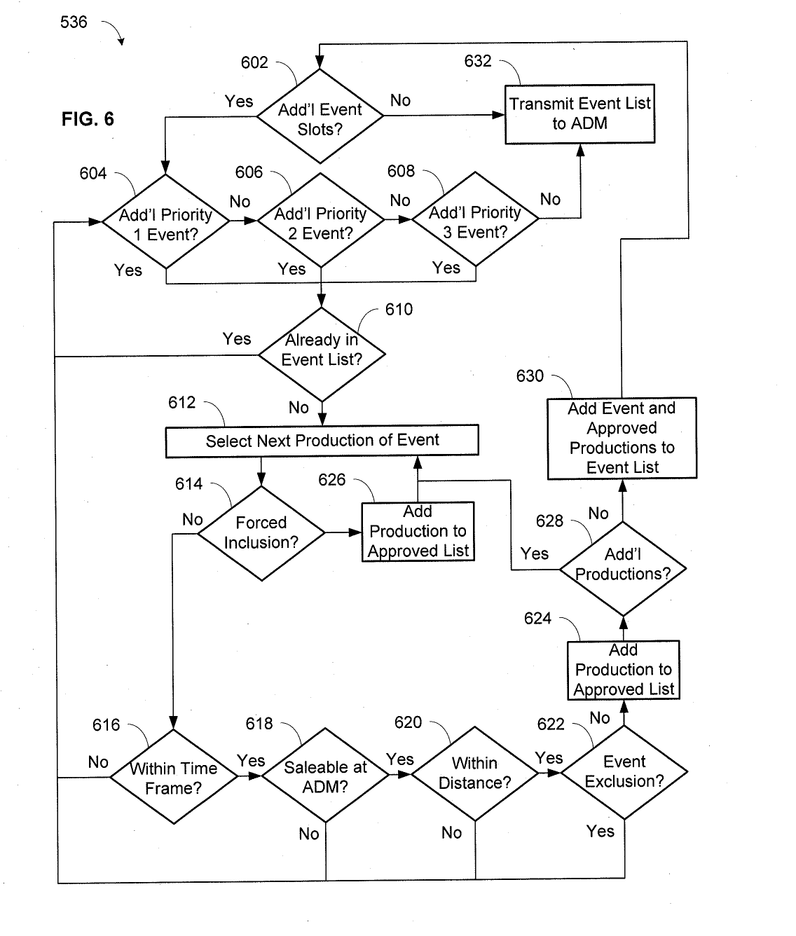

As described above, the process 500 may continue to step 536 to fill remaining event slots in the listing of events, if each of the categories for the listing of events has reached the minimum threshold of events, or if there are no remaining prospective events with an appropriate assigned priority. The process 536 shown in FIG. 6 may correspond to step 536 of the process 500 in FIG. 5. The process 536 may result in filling any remaining event slots in the listing of events, prior to transmitting the listing of events to the article dispensing machine 230. The process 536 may utilize similar criteria when reviewing prospective events as in the process 500 described above.

At step 602, it may be determined whether any remaining event slots exist in the listing of events. If there are no remaining event slots in the listing of events, then the process 536 may continue to step 632. At step 632, the listing of events may be transmitted to the article dispensing machine 230. Once received, the article dispensing machine 230 may display one or more of the listing of events on the user interface 234, as described above. The number of event slots in the listing of events may be static or dynamic. For example, the number of event slots in the listing of events may be 120.

However, if there are remaining event slots in the listing of events, then the process 536 may continue to step 604. At step 604, it can be determined whether any prospective events with an assigned priority of 1 (e.g., the highest priority) have been considered yet. If there are prospective events with an assigned priority of 1, then the process 536 can continue to step 610 to determine whether the particular prospective event is already in the listing of events. However, if there are not prospective events with an assigned priority of 1, then the process 536 can continue to step 606 to determine whether any prospective events with an assigned priority of 2 (e.g., the next highest priority) have been considered yet. If there are prospective events with an assigned priority of 2, then the process 536 can continue to step 610 to determine whether the particular prospective event is already in the listing of events. However, if there are not prospective events with an assigned priority of 2, then the process 536 can continue to step 608 to determine whether any prospective events with an assigned priority of 3 (e.g., the lowest priority) have been considered yet. If there are no unconsidered prospective events with an assigned priority of 3, then the process 536 can continue to step 610 to determine whether the particular prospective event is already in the listing of events. If there are not prospective events with an assigned priority of 3, then the process 536 can continue to step 632 to transmit the listing of events to the article dispensing machine 230. It should be noted that any number of assigned priorities are possible for the prospective events, and that three levels of assigned priorities is merely exemplary.

If a prospective event exists for consideration, then it can be referred to as an event under consideration. If it is determined that the event under consideration is already in the listing of events at step 610, then the process 536 may discard the event under consideration from further review and return to step 604 to determine another event under consideration. If it is determined that the event under consideration is not already in the listing of events at step 610, then the process 536 may continue to step 612. At step 612, a next production of the event under consideration can be selected for review. Whether the next production includes a forced inclusion flag may be determined at step 614. If the forced inclusion flag is set at step 614, then the next production may be added to the approved list of productions at step 626. The process 536 may then return to step 612 to select a next production of the event under consideration. However, if the forced inclusion flag is not set at step 614, the process 500 may continue to step 616.

At step 616, it may be determined whether the next production is within an upcoming timeframe of the current date and time. If the next production is not within the upcoming timeframe at step 616, then the process 536 may discard the event under consideration from further review and return to step 604 to determine another event under consideration. If the next production is within the upcoming timeframe at step 616, then the process 536 may continue to step 618. It may be determined at step 618 whether the next production is saleable at the article dispensing machine 230. If the next production is not saleable at step 618, then the process 536 may discard the event under consideration from further review and return to step 604 to determine another event under consideration. If the next production is saleable at step 618, then the process 536 may continue to step 620.

It can be determined at step 620 whether a location of the next production of the event under consideration is within a proximity of the location of the article dispensing machine 230. The location of the article dispensing machine 230 may have been previously determined at step 502. If the location of the next production is not within the proximity of the location of the article dispensing machine 230 at step 620, then the process 536 may discard the event under consideration from further review and return to step 604 to determine another event under consideration. If the location of the next production is within the proximity of the location of the article dispensing machine 230 at step 620, then the process 536 may continue to step 622. At step 622, it may be determined whether the event under consideration satisfies one or more exclusion criteria associated with a ticket ordering allowability. If the event under consideration satisfies the exclusion criteria at step 622, then the process 536 may discard the event under consideration from further review and return to step 604 to determine another event under consideration. However, if the event under consideration does not satisfy the exclusion criteria at step 622, then the process 536 may continue to step 624.

At step 624, the next production of the event under consideration may be added to the approved list of productions for the event. It may be determined at step 628 whether there are additional productions for the event under consideration. If there are additional productions for the event under consideration, then the process 536 may return to step 612 to select a next production of the event under consideration. However, if there are not additional productions for the event under consideration at step 628, then at step 630, the event under consideration and the approved list of productions for the event under consideration may be added to the listing of events for the article dispensing machine 230. The process 536 may return to step 602 following step 630 to determine whether any event slots remain in the listing of events. If there are no remaining event slots in the listing of events, then the process 536 may continue to step 632. At step 632, the listing of events may be transmitted to the article dispensing machine 230. Once received, the article dispensing machine 230 may display one or more of the listing of events on the user interface 234, as described above.

An example of the processes 500 and 600 for curating a listing of events is described as follows. The process 500 can be utilized to determine a base set of events so that each category has a minimum number of events, e.g., eight events for the categories music, sports, theater and arts, family, and other. In this example, the music category already has five events, the sports category already has eight events, the theater and arts category already has eight events, the family category already has six events, and the other category has three events. Using the process 500, assuming all other criteria is met, the following prospective events will be included in the listing of events: (1) two events in the music category with priority 1 (because the music category is below minimum); (2) an event in the family category with priority 2 (because the family category is below minimum); (3) an event in the other category with priority 2 (because the other category is below minimum); and (4) an event in the music category with priority 2 (because the music category is below minimum, but with the addition of this event, the music category has reached minimum). The following prospective events would not be included in the listing of events: (1) an event in the sports category with priority 1 (because the sports category is at its minimum); (2) an event in the theater and arts category with priority 2 (because the theater and arts category is at its minimum); and (3) an event in the music category with priority 3 (because the music category is at its minimum).

Following the process 500, there may still be remaining event slots in the listing of events. In particular, if the maximum number of slots is 120, then after the process 500, there are 35 total events (i.e., music category: eight, sports category: eight, theater and arts category: eight, family category: seven, and other category: four). The process 600 can be utilized to fill the remaining event slots. Assuming all other criteria is met and that a prospective event is not already in the listing of events, all prospective events can be included in the listing of events until the maximum number of slots is filled.

Any process descriptions or blocks in figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method of curating a listing of a plurality of events for ticket ordering at an article dispensing machine, each of the plurality of events in each of a plurality of categories and derived from a plurality of prospective events, wherein each of the plurality of events and the plurality of prospective events has one or more productions, a category, and a priority ranking, wherein each of the one or more productions has a date and time and a venue location, wherein the article dispensing machine has a processor configured to communicate with a central processor via a network, the method comprising:
(a) determining a location of the article dispensing machine, using the central processor;
(b) determining an event under consideration from the plurality of prospective events stored in a database, based on the priority ranking of the event under consideration, using the central processor;
(c) selecting a next production of the one or more productions associated with the event under consideration, the next production comprising one of the one or more productions based on chronological order, using the central processor;
(d) determining whether the date and time of the next production is within an upcoming timeframe, using the central processor;
(e) if the date and time of the next production is not within the upcoming timeframe:
discarding the event under consideration from further review, using the central processor; and
returning to step (b) to determine the event under consideration;
(f) if the date and time of the next production is within the upcoming timeframe, determining the category of the event under consideration, using the central processor;
(g) determining whether the category of the event under consideration has reached a minimum threshold for the listing of the plurality of events, using the central processor;
(h) if the category of the event under consideration has reached the minimum threshold:
discarding the event under consideration from further review, using the central processor; and
returning to step (b) to determine the event under consideration;
(i) if the category of the event under consideration has not reached the minimum threshold, determining whether the venue location is within a proximity of the location of the article dispensing machine, using the central processor;
(j) if the venue location is not within the proximity of the location of the article dispensing machine:
discarding the event under consideration from further review, using the central processor; and
returning to step (b) to determine the event under consideration;
(k) adding the next production to an approved list of productions for the event under consideration, using the central processor;
(l) repeating steps (c)-(k) for each of the one or more productions associated with the event under consideration;
(m) adding the event under consideration and the approved list of productions to the listing of the plurality of events stored in the database, using the central processor;
(n) repeating steps (b)-(m) for each of the plurality of prospective events; and
(o) transmitting the listing of the plurality of events from the central processor to the processor of the article dispensing machine.

2. The method of claim 1, further comprising:
determining whether each of the plurality of categories of the listing has reached the minimum threshold for the listing of the plurality of events, using the central processor, following step (m); and
if each of the plurality of categories of the listing has not reached the minimum threshold, returning to step (b).

3. The method of claim 2, further comprising, if each of the plurality of categories of the listing has reached the minimum threshold:
determining whether the listing of the plurality of events has reached a maximum quantity, using the central processor;
if the listing of the plurality of events has reached the maximum quantity, executing step (o);
if the listing of the plurality of events has not reached the maximum quantity:
executing step (b);
determining whether the event under consideration is in the listing of the plurality of events, using the central processor;
if the event under consideration is not in the listing of the plurality of events, executing steps (c)-(m) for the event under consideration;
determining whether the listing of the plurality of events has reached the maximum quantity, using the central processor; and
if the listing of the plurality of events has reached the maximum quantity, executing step (o).

4. The method of claim 1, wherein the location comprises one or more of a zip code, a latitude and longitude, retailer account information, or a time zone.

5. The method of claim 1, wherein determining the event under consideration comprises:
determining whether any of the plurality of prospective events have not been discarded from further review; and
selecting the event under consideration from the plurality of prospective events that have not been discarded from further review.

6. The method of claim 1, wherein determining the event under consideration comprises selecting the event under consideration from the plurality of prospective events if the priority ranking of the event under consideration is higher than the priority ranking of another of the plurality of prospective events.

7. The method of claim 1:
wherein each of the one or more productions further has a forced inclusion flag;
the method further comprising:
determining whether the forced inclusion flag of the next production is set, using the central processor;
if the forced inclusion flag of the next production is not set:
discarding the event under consideration from further review, using the central processor; and
returning to step (b) to determine the event under consideration; and
if the forced inclusion flag of the next production is set, adding the next production to the approved list of productions for the event under consideration, using the central processor.

8. The method of claim 1:
wherein each of the plurality of prospective events further has exclusion criteria associated with a ticket ordering allowability;
the method further comprising:
determining whether the exclusion criteria of the event under consideration is satisfied, using the central processor;
if the exclusion criteria is satisfied:
discarding the event under consideration from further review, using the central processor; and
returning to step (b) to determine the event under consideration; and
if the exclusion criteria is not satisfied, adding the next production to the approved list of productions for the event under consideration, using the central processor.

9. The method of claim 8, wherein the exclusion criteria comprises one or more of a location restriction, a legal restriction, or a contractual restriction.

10. The method of claim 1, further comprising:
if the date and time of the next production is within the upcoming timeframe, determining whether the next production is saleable on the article dispensing machine, using the central processor;
if the next production is not saleable on the article dispensing machine:
discarding the event under consideration from further review, using the central processor; and
returning to step (b) to determine the event under consideration; and
if the next production is saleable on the article dispensing machine, determining the category of the event under consideration, using the central processor.

11. The method of claim 1, further comprising:
determining a demographic profile associated with the article dispensing machine, using the central processor;
determining whether the demographic profile satisfies a demographic criteria of the event under consideration, using the central processor;
if the demographic profile does not satisfy the demographic criteria:
discarding the event under consideration from further review, using the central processor; and
returning to step (b) to determine the event under consideration; and
if the demographic profile satisfies the demographic criteria, executing steps (c)-(o).

12. A method of managing a ticket order transaction at an article dispensing machine, the ticket order transaction related to an event having a plurality of productions, the article dispensing machine having a user interface connected to a processor and configured to communicate with a central processor via a network, the method comprising:
transmitting a production listing page from the processor to the user interface, the production listing page comprising event details and selectable listings of at least one of the plurality of productions, wherein the selectable listings of the at least one of the plurality of productions comprises a date and time of the at least one of the plurality of productions and a ticket price of the at least one of the plurality of productions;
receiving at the processor from the user interface a selection of one of the selectable listings on the production listing page, the selection denoting a desired production of the at least one of the plurality of productions;
transmitting a quantity selection page from the processor to the user interface, in response to receiving the selection of one of the selectable listings, the quantity selection page comprising a ticket quantity input element for denoting a desired quantity of tickets related to the desired production;
receiving at the processor from the user interface the desired quantity of tickets entered at the ticket quantity input element;
querying by the processor to the central processor for a ticket availability based on the desired quantity of tickets and the desired production;
transmitting a seat selection page from the processor to the user interface, the seat selection page comprising the ticket availability, the ticket availability comprising one or more of a best seat option or a best value option, wherein:
the best seat option corresponds to a highest ranking available ticket; and
the best value option corresponds to a lowest price available ticket;
receiving at the processor from the user interface a selection of the best seat option or the best value option on the seat selection page;
transmitting a delivery selection page from the processor to the user interface, the delivery selection page comprising one or more selectable delivery options related to the ticket order transaction;
receiving at the processor from the user interface a selection of one of the one or more selectable delivery options on the delivery selection page;
transmitting a purchase summary page from the processor to the user interface, the purchase summary page comprising the desired production, a total price derived from the selection of the best seat option or the best value option, and a selectable order completion button;
receiving at the processor from the user interface a selection of the selectable order completion button on the purchase summary page, the selection of the selectable order completion button denoting completion of the ticket order transaction; and
transmitting from the processor to the central processor the ticket order transaction.

13. The method of claim 12, wherein the event details comprise one or more of an event artwork or an event description.

14. The method of claim 12:
wherein the production listing page further comprises a selectable reminder button;
the method further comprising:
receiving at the processor from the user interface a selection of the selectable reminder button on the production listing page;
transmitting a reminder entry page from the processor to the user interface, the reminder entry page comprising a communication input field;
receiving at the processor from the user interface a communication address from the communication input field, wherein the communication address comprises one or more of an email address or a phone number;
transmitting from the processor to the communication address a reminder notification related to the event; and
storing in the database a tracking identifier, using the processor, wherein the tracking identifier uniquely identifies the article dispensing machine and the ticket order transaction.

15. The method of claim 12, wherein the listing of the at least one of the plurality of productions comprises a calendar view comprising the at least one of the plurality of productions in one or more of a daily format, weekly format, or monthly format.

16. The method of claim 12, wherein the one or more selectable delivery options comprises a will call option, a print-at-home option, a mobile delivery option, a mobile barcode option, a Flash Seats option, or an Apple Passbook option.

17. The method of claim 16, further comprising:
transmitting a payment page from the processor to the user interface;
receiving payment information from the payment page at the processor from the user interface; and
if the selection of one or the one or more selectable delivery options comprises the will call option:
transmitting a will call name entry page from the processor to the user interface, the will call name entry page comprising a name entry field, the name entry field populated with a derived name based on the payment information;
receiving at the processor from the user interface a name from the name entry field, the name comprising the derived name or an entered name; and
transmitting from the processor to the central processor the name as part of the ticket order transaction.

18. The method of claim 12, further comprising:
transmitting an order confirmation communication page from the processor to the user interface, the order confirmation communication page comprising a communication input field;
receiving at the processor from the user interface a communication address from the communication input field, wherein the communication address comprises one or more of an email address or a phone number; and
transmitting from the processor to the communication address a ticket order confirmation related to the ticket order transaction.

19. The method of claim 12, wherein the seat selection page further comprises an interactive seat map configured to allow a selection of a seat corresponding to the ticket availability.

20. The method of claim 12, further comprising:
receiving a customer identifier at the processor from the user interface, the customer identifier for uniquely identifying a customer;
querying by the processor to the central processor for a transaction history associated with the customer, based on the customer identifier, wherein the transaction history is related to a rental or a purchase of one or more of a media article or a media selection, wherein the media article comprises at least one of a digital video disc, a Blu-Ray disc, or a video game, and the media selection comprises at least one of a video on demand, a streaming video, a downloadable video, a streaming video game, or a downloadable video game;
determining a plurality of events to display on an events browse page, based on the transaction history, using the processor, wherein the plurality of events comprises the event and other events, and wherein the events browse page comprises selectable listings of the plurality of events, each selectable listing including a ticket price for each of the plurality of events;
transmitting the events browse page from the processor to the user interface; and
receiving at the processor from the user interface a selection of one of the selectable listings of the plurality of events on the events browse page;
wherein transmitting the production listing page comprises transmitting the production listing page from the processor to the user interface, in response to receiving the selection of one of the selectable listings of the plurality of events, wherein the production listing page relates to the at least one of the plurality of productions of the event.

21. The method of claim 12, further comprising:
transmitting an events browse page from the processor to the user interface, wherein the events browse page comprises selectable listings of a plurality of events, the plurality of events comprising the event and other events, and each selectable listing including a ticket price for each of the plurality of events; and
receiving at the processor from the user interface a selection of one of the selectable listings of the plurality of events on the events browse page;
wherein transmitting the production listing page comprises transmitting the production listing page from the processor to the user interface, in response to receiving the selection of one of the selectable listings of the plurality of events, wherein the production listing page relates to the at least one of the plurality of productions of the event.

22. The method of claim 12, wherein the best value option takes into a ranking of an available ticket in the ticket availability.

23. A method of curating a listing of a plurality of events for ticket ordering at an article dispensing machine, each of the plurality of events in each of a plurality of categories and derived from a plurality of prospective events, wherein each of the plurality of events and the plurality of prospective events has one or more productions, a category, and a priority ranking, wherein each of the one or more productions has a date and time and a venue location, wherein the article dispensing machine has a processor configured to communicate with a central processor via a network, the method comprising:
(a) determining a location of the article dispensing machine, using the central processor;
(b) determining an event under consideration from the plurality of prospective events stored in a database, based on the priority ranking of the event under consideration, using the central processor;
(c) selecting a next production of the one or more productions associated with the event under consideration, the next production comprising one of the one or more productions based on chronological order, using the central processor;
(d) determining whether the date and time of the next production is within an upcoming timeframe, using the central processor;
(e) if the date and time of the next production is not within the upcoming timeframe:
discarding the event under consideration from further review, using the central processor; and
returning to step (b) to determine the event under consideration;
(f) if the date and time of the next production is within the upcoming timeframe, determining whether the venue location is within a proximity of the location of the article dispensing machine, using the central processor;
(g) if the venue location is not within the proximity of the location of the article dispensing machine:
discarding the event under consideration from further review, using the central processor; and
returning to step (b) to determine the event under consideration;
(h) adding the next production to an approved list of productions for the event under consideration, using the central processor;
(i) repeating steps (c)-(h) for each of the one or more productions associated with the event under consideration;
(j) adding the event under consideration and the approved list of productions to the listing of the plurality of events stored in the database, using the central processor;
(k) repeating steps (b)-(j) for each of the plurality of prospective events; and
(l) transmitting the listing of the plurality of events from the central processor to the processor of the article dispensing machine.

24. The method of claim 23, further comprising:
if the date and time of the next production is within the upcoming timeframe, determining the category of the event under consideration, using the central processor;
determining whether the category of the event under consideration has reached a minimum threshold for the listing of the plurality of events, using the central processor;
if the category of the event under consideration has reached the minimum threshold:
discarding the event under consideration from further review, using the central processor; and
returning to step (b) to determine the event under consideration; and
if the category of the event under consideration has not reached the minimum threshold, determining whether the venue location is within the proximity of the location of the article dispensing machine, using the central processor.
